(19) United States
(12) Patent Application Publication
(10) Pub. No.: US 2010/0105307 A1
(43) Pub. Date: Apr. 29, 2010

(54) HAND-OPERABLE MEAT TENDERIZER AND MARINATOR

(76) Inventor: Israel Harry Zimmerman, Los Angeles, CA (US)

Correspondence Address: WALTER W. DUFT;LAW OFFICES OF WALTER W. DUFT, 8616 MAIN ST, SUITE 2, WILLIAMSVILLE, NY, 14221, US

(21) Appl. No.: 12/582,371

(22) Filed: Oct. 20, 2009

Related U.S. Application Data
(60) Provisional application No. 61/106,632, filed on Oct. 20, 2008.

(51) Int. Cl. A22C 9/00; A23L 1/318

(52) U.S. Cl. 452/141

(57) ABSTRACT

A hand-operable meat preparation device includes a handle, a meat tenderizer controllable through the handle to tenderize a cut of meat while introducing vibrational or other work forces therein, and a marinator controllable through the handle to internally marinate the meat with assistance from the vibrational or other work forces introduced by the tenderizer. During use, a person grasps the handle and tenderizes the meat with the meat tenderizer while marinating the meat with the marinator as the tenderizer sets up the vibrational or other work forces in the meat to assist the marination.

### CROSS REFERENCE TO RELATED APPLICATIONS

This application claims benefit of the filing date of U.S. Provisional Patent Application No. 61/106,632, filed on Oct. 20, 2009 and entitled “Hand-Operable Meat Tenderizer And Marinator.” The entire contents of said application are fully incorporated herein by this reference.

### BACKGROUND OF THE INVENTION

1. Field of the Invention

The present invention relates to food preparation. More particularly, the invention is directed to the tenderizing and marinating of meat for cooking

2. Description of the Prior Art

By way of background, various techniques have been used to tenderize and marinate meats so that they are not tough and hard to chew, and to improve their taste. Tenderizing methods include pounding using a tenderizing mallet or other instrument, and piercing using a mechanical tenderizer having sharp blades. U.S. Pat. No. 4,199,841 of Jaccard is illustrative of the latter type of tenderizer. It features a handle that mounts a set of tenderizing blades. A spring-biased stripping plate normally covers the ends of the blades. The stripping plate retracts when the device is pressed downwardly on a cut of meat and the blades are driven into the meat interior. Marinating methods include external marination by soaking the meat in a liquid marinade. There are also internal marinating devices that can be used to directly introduce marinade into the interior of the meat. Such devices typically include a marinade holder and one or more injectors for injecting the marinade into the meat. As far as known, there are no devices that combine both tenderizing and marinating in one hand-held instrument. Nor is applicant aware of any prior art literature that discloses how these functions could be performed in a cooperative manner.

### SUMMARY OF THE INVENTION

A hand-operable meat preparation device includes a handle, a meat tenderizer controllable through the handle to tenderize a cut of meat while introducing vibrational or other work forces therein, and a marinator controllable through the handle to internally marinate the meat with assistance from the vibrational or other work forces introduced by the tenderizer. During use, a person grasps the handle and tenderizes the meat with the meat tenderizer while marinating the meat with the marinator as the tenderizer sets up the vibrational or other work forces in the meat to assist the marination.

### BRIEF DESCRIPTION OF THE DRAWINGS

The foregoing and other features and advantages of the invention will be apparent from the following more particular description of an example embodiment, as illustrated in the accompanying Drawings in which:

FIG. 1 is a front perspective view showing an example embodiment of a hand-operable meat preparation device;

FIG. 2 is a rear perspective view showing the device of FIG. 1;

FIG. 3 is a bottom perspective view showing the device of FIG. 1;

FIG. 4 is an exploded perspective view showing an example housing assembly that may be used in the device of FIG. 1;

FIG. 5 is an exploded perspective view showing the device of FIG. 1;

FIG. 6 is an exploded perspective view showing an example battery compartment assembly that may be used in the device of FIG. 1;

FIG. 7 is an exploded perspective view showing an example pump and vibrator assembly that may be used in the device of FIG. 1;

FIG. 8 is a perspective view showing an example blade and marination needle assembly that may be used in the device of FIG. 1;

FIG. 9 is an exploded perspective view showing an example marination flow path that may be provided in the device of FIG. 1; and

FIG. 10 is an exploded perspective view showing an example safety cover and trigger assembly that may be used in the device of FIG. 1.

### DETAILED DESCRIPTION OF EXAMPLE EMBODIMENTS

### A. Introduction

Applicant has developed an improved meat preparation device that allows a cut of meat to be simultaneously tenderized and marinated in a highly effective cooperative manner. The device includes a handle, a tenderizer and a marinator. The tenderizer is controllable through the handle to tenderize a cut of meat while introducing vibrational or other work forces therein that promote and facilitate the marinator's marinating action. In the disclosed example embodiment, the tenderizer includes a plurality of tenderizing blades that pierce the meat during tenderizing and help cut and separate internal connective tissue. The tenderizer imparts vibrational or other work forces to the meat due to its ability to control and influence the meat externally in two or more directions, as well as internally within the meat interior. In addition to this natural vibration/working action, the tenderizer may deliver vibrational or other work forces generated by a motorized vibrator that vibrates at a desired frequency. As a result of the vibrational or other work forces applied during tenderizing, a synergistic effect is created that assists the marinator. The marinade will flow more quickly and thoroughly into and through the meat, particularly in the example embodiment where tenderizing blades are present due to their ability to cut channels within the meat that help distribute the marinade. This increases the effectiveness of the marinade and is superior to conventional marinating wherein a cut of meat is simply soaked in a marinating solution or injectors merely inject marinade inside the meat at discrete piercing locations.

### B. Example Embodiment

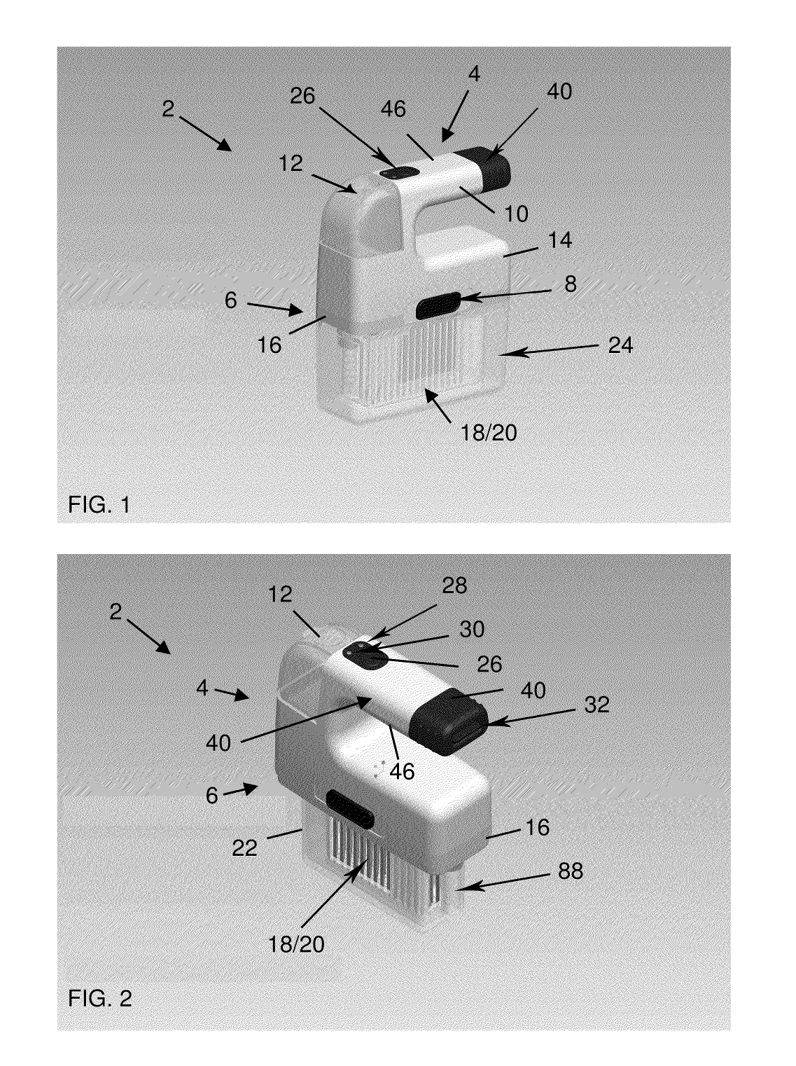

Turning now to the drawing figures, FIGS. 1-3 illustrate a hand-operable meat tenderizer and marinator 2 constructed in accordance with the example embodiment. The device 2 includes a top body 4 and a bottom body 6 that are releasably interconnected by a pair of safety slide locks 8 located on the sides of the device. The slide locks 8 allow the top body 4 to be detached from the bottom body 6 so that the latter may be cleaned.

The top body 4 includes an upper handle 10, a removable marinade tank 12, and a lower compartment 14 that houses marinade pumping components and vibration motor components. The marinade pumping components may be provided by a manual pump apparatus as typically used in water guns or spray bottles. Alternatively, as shown and described below, a motorized pump may be used. The bottom body 6 includes a fixed base 16 that mounts a set of meat tenderizing blades 18 and marination needles 20, a slidable safety cover 22 that retracts to expose the tenderizing blades and marination needles during operation, and a detachable blade/needle cover 24 for use when storing the tenderizer 2.

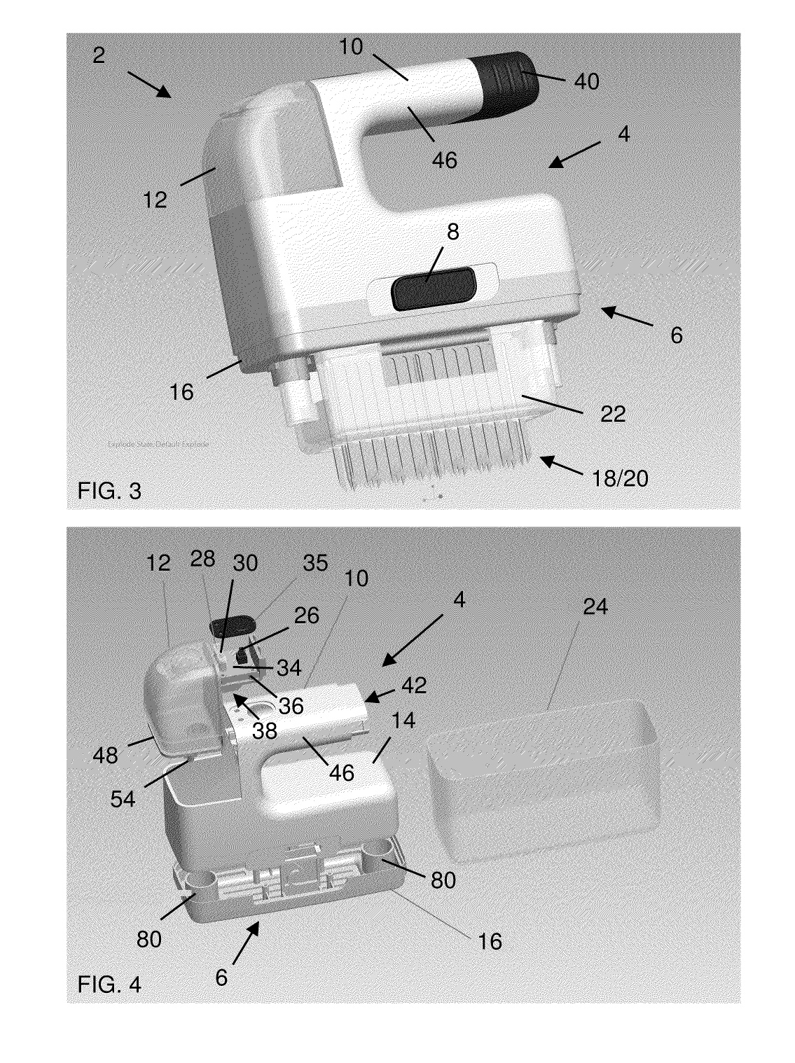

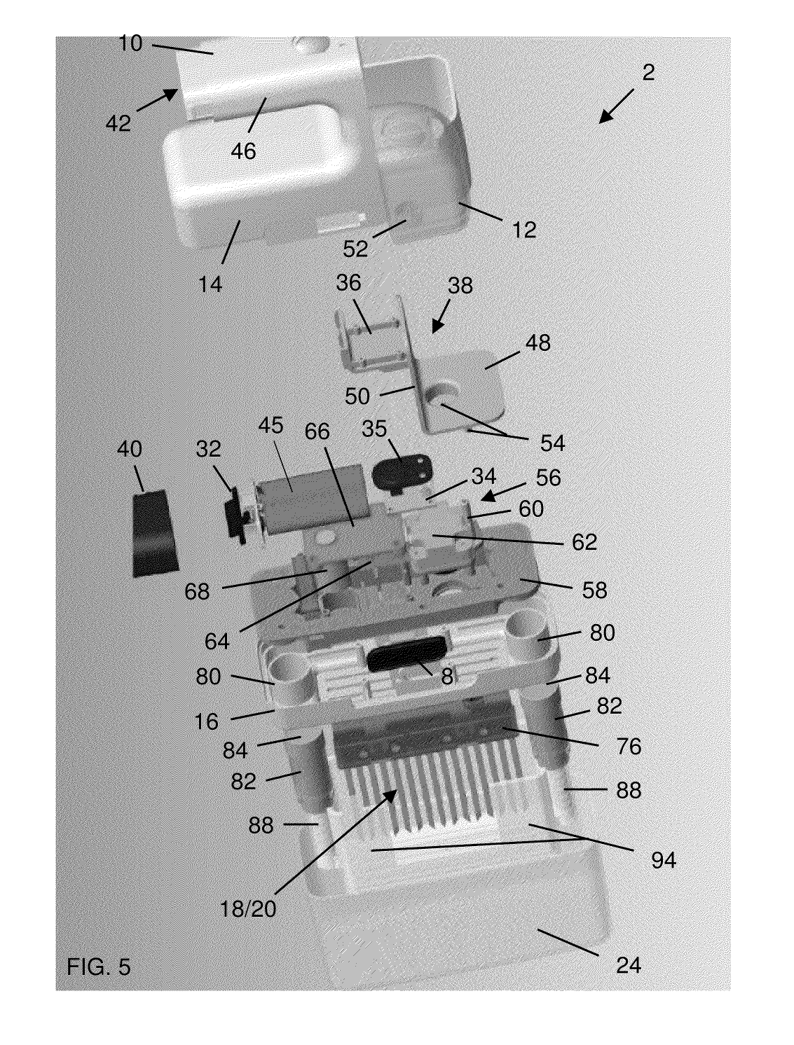

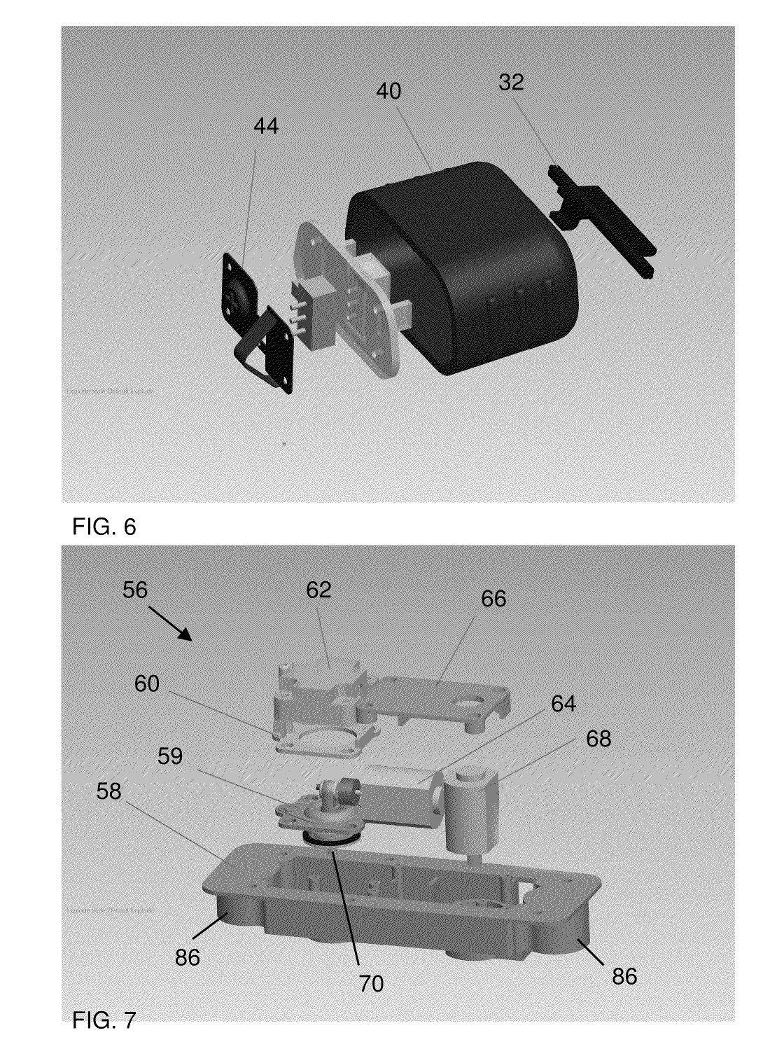

The handle portion 10 of the top body 4 includes a marination pump activation switch 26, a vibration indicator light 28, a marination indicator light 30, and a power on/off switch 32. As additionally shown in FIGS. 4 and 5, the marination pump activation switch 26, the vibration indicator light 28, and the marination indicator light 30 may be mounted on a printed circuit board (PCB) 34 that is covered by a switch plate 35. This printed circuit board attaches to an upper horizontal leg 36 of an S-shaped component support fitting 38. The power switch 32 extends from a removable battery door 40 that opens to a battery housing 42 within the handle interior. As shown in FIG. 6, the battery housing 42 includes the usual battery contacts 44 for connecting a set of batteries 45 (see FIG. 5) to the tenderizer's internal electrical circuit. The power switch 32 allows the battery power to be switched on and off. The handle 10 also includes a hand-receiving area 46 between the marination switch 26 and the battery door 40. This area is where the tenderizer 2 is grasped during use. The marination pump activation switch 26 is immediately forward of the hand-receiving area 46, allowing it to be activated by the user's thumb while holding the tenderizer 2.

The marination tank 12 is for holding liquid marinade. It rests on a lower horizontal leg 48 of the S-shaped component fitting 38 (see FIGS. 4 and 5) and is removable from the top body 4 for filling and cleaning. An intermediate vertical leg 50 of S-shaped component support fitting 38 (see FIG. 5) runs along the back of the marination tank 12. An exit port 52 at the bottom of the marination tank 12 (see FIG. 5) connects to, and discharges marinade through, a marinade aperture 54 in the lower leg 48 of the S-shaped component support fitting 38. The marinade aperture 54 connects to a marination pump 56 carried by a pump holder 58 within the lower compartment 14 of the top body 4. As best shown in FIG. 7, the marination pump 56 includes a marination pump valve 59, a marinade pipe 60 connected to the marinade aperture 54 in the S-shaped component support fitting 38, a pump cover 62, and a marination pump motor 64. A motor support cover 66 is positioned to cover and support the upper portion of the marination pump motor 64. It also covers and supports the upper portion of a vibration motor 68 that is adapted to vibrate during tenderizing. The lower portion of the marination pump motor 64 and the lower portion of the vibration motor 68 are supported on the pump holder 58.

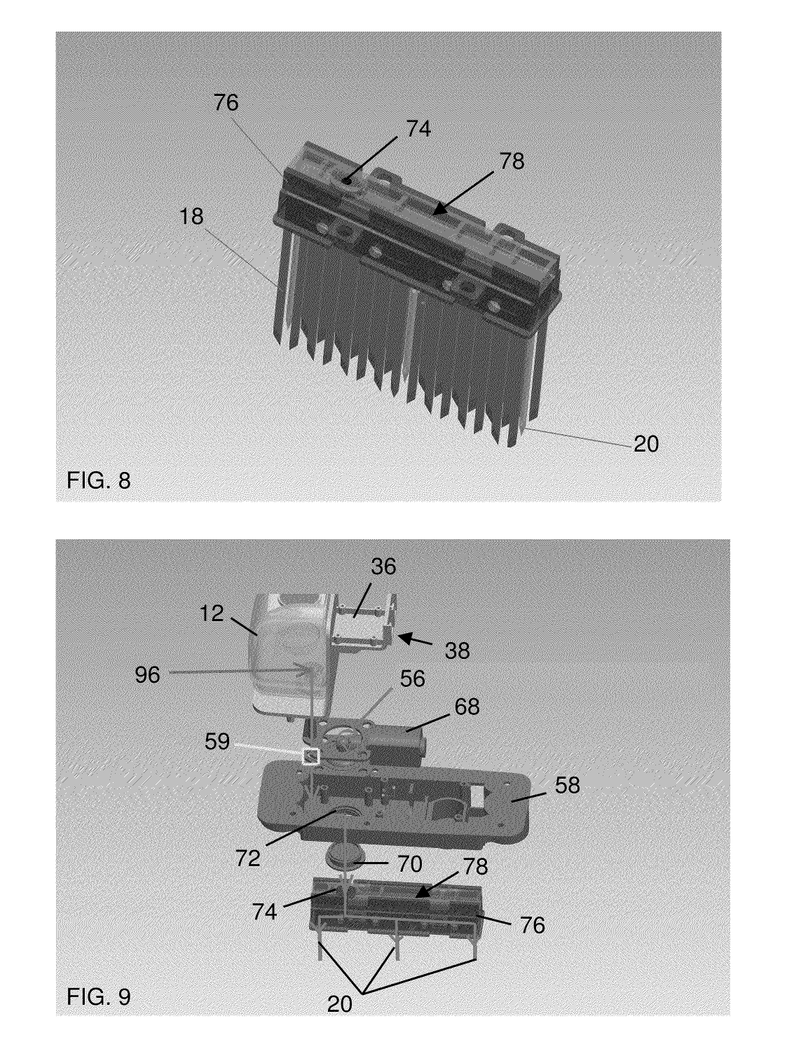

The marination pump 54 discharges marinade through a discharge port 70 that seats in an aperture 72 in the pump holder 58 that leads to the bottom body 6. As can be seen in FIGS. 8 and 9, the discharge port 70 removably connects to a port 74 provided on a blade holder 76 carried by the fixed base 16 of the bottom body 6. The blade holder 76 has a manifold 78 that distributes marinade from the discharge port 70 to the marination needles 20, which are fixedly mounted to the blade holder. The drawings figures show three marination needles 20, but any desired number of such needles may be used. Each marination needle 20 is hollow to facilitate marinade flow. The upper base end of each needle is in fluid communication with the blade holder marination channel in the manifold 78. The lower tip end of each marination needle 20 has a marinade discharge port.

The tenderizing blades 18 are also supported by the blade holder 76. The tenderizing blades 18 shown in the drawing figures are arranged in three rows of 12-15 blades each, but any desired number and arrangement of such blades may be used. The center row of tenderizing blades 18 also includes the three marination needles 20. Within each row, the tenderizing blades 18 are may be arranged in pairs of blades whose blade edges are angled in different directions. The blade holder 76 mounts to the fixed base 16 of the bottom body 6, which is slotted to pass the tenderizing blades 18 and the marination needles 20 so that they extend downwardly from the fixed base.

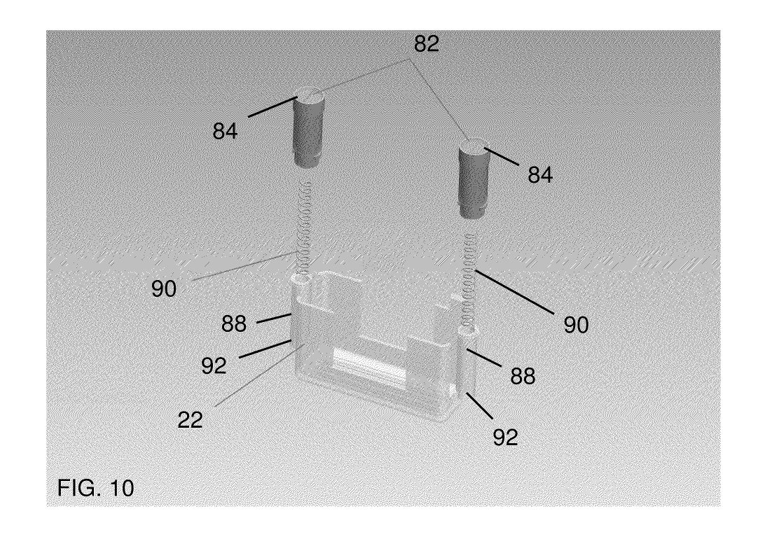

Returning now to FIGS. 2 and 3, the fixed base 16 slidably mounts the safety cover 22 that retracts to expose the tenderizing blades 18 and the marination needles 20 during use. To that end, the fixed base 16 is formed with a pair of large circular bores 80 that carry a pair of fixed spring holders 82 (see FIGS. 4 and 5). The spring holders 82 are tubular, but have closed upper ends 84. The outside portions of the spring holder closed ends 84 register with receptacles 86 (see FIG. 7) formed on the pump holder 58 when the top body 4 and the bottom body 6 are interconnected. The inside portions of the spring holders 82 telescopically receive a pair of hollow guide posts 88 formed on the safety cover 24 (see FIGS. 5 and 9). The guide posts 88 are open at their top end and closed at their bottom end. As shown in FIG. 10, a compression spring 90 is received in each spring holder 82, and extends downwardly into the guide posts 88. The upper ends of the compression springs 90 bottom out against the closed upper ends 84 of the spring holders 82. The lower ends of the compression springs 90 bottom out against the closed lower ends 92 of the guide posts 88.

The compression springs 90 provide a biasing force that biases the safety cover 22 downwardly to cover the tenderizing blades 18 and the marination needles 20. When an upward force is applied to the safety cover 22 (as when pressing its slotted bottom against a cut of meat to be tenderized), the guide posts 88 will retract into the spring holders 82 against the biasing force of the compression springs 90. As the safety cover retracts 22, its sides 94 (four such structures are shown in FIG. 10) will simultaneously pass through corresponding slots (not shown) formed in the fixed base 16, allowing the entire upper portion of the safety cover to retract into the fixed base and thereby expose the tenderizing blades 18 and the marination needles 20. A switch (not shown) located within one or both of the spring holders 82 may be provided to detect when the safety cover 22 has retracted a selected amount. When the switch is activated, power is supplied to the marination pump 56 (assuming the marination pump activation switch 26 has been activated), and to the vibration motor 68.

During operation of the device 2, a person grasps the handle 10, activates the power on/off switch 32, activates the marination pump activation switch 26, and repeatedly presses the slotted bottom of the safety cover 22 against a cut of meat to be tenderized in a series of tenderizing strokes aimed at different areas of the meat. As the device 2 is pushed downwardly, the safety cover 22 retracts into the fixed base 16 of the bottom body 6 while the tenderizing blades 18 and the marination needles pierce the meat 20. The compression springs 90 provide downward pressure to the safety cover 22 so that the latter will hold the meat in place against the underlying surface and may also provide a hammering force on the meat depending on how vigorously the downstroke is applied. At the very least, the meat will be squeezed and manipulated such that manual vibrational or other work forces are imparted thereto, even without activation of the vibration motor 68. At the same time, the tenderizing blades 18 will cut into the meat, thereby imparting additional forces as well as creating passageways through which marinade will be distributed remotely from the holes made by the marination needles 20 (see below). If the user moves his or her hand in any direction other than a strict vertical motion, lateral forces will also be introduced. For example, such forces could be generated by moving the device 2 forward or backward, or side to side, or by rocking the device, during each downstroke.

When the safety cover 22 retracts to a selected point, the marination pump 56 and the vibration motor 68 are activated. As shown in FIG. 9, the marination pump 56 pumps marinade along a marination flow path 96 that begins at the marination tank 12 and ends at the discharge ports on the marination needles 20, which are thrust into the meat. The vibrations emitted by the vibration motor 68 pass into the tenderizing blades 18, causing them to vibrate rapidly. This augments the tenderizing effect of the blades 18 and promotes marinade flow throughout the meat. As stated, the device 2 may be repeatedly pressed downwardly into the meat, withdrawn from the meat and pressed downwardly again at a different location. Each time the device 2 is pressed downwardly, a combination of tenderizing and marination actions will be applied to the meat in a synergistic manner, causing it to tenderize and marinate more quickly and thoroughly than if tenderizing and marinating were performed as separate operations.

Following use of the device 2, the top body 4 may be unlocked from the bottom body 6 by sliding the slide locks 8. The bottom body 6 may then be washed (e.g., in a dishwasher) to remove food matter from the tenderizing blades 18 and the marination needles 20.

Accordingly, a hand-operable meat tenderizer and marinator has been disclosed. While an example embodiment has been shown and described, it should be apparent that many variations and alternative embodiments could be implemented in accordance with the teachings herein. For example, as stated above, manual vibrational or other work forces introduced by the device 2 are provided by the natural motion and action of the device during use. Thus, if desired, the vibration motor 58 could be eliminated so that the vibrational and other work forces are generated solely by way of manual action. It is understood, therefore, that the invention is not to be in any way limited except in accordance with the spirit of the appended claims and their equivalents.

What is claimed is:

1. A hand-operable meat preparation device, comprising:
a handle;
a meat tenderizer controllable through said handle to tenderize a cut of meat while introducing vibrational or other work forces therein; and
a marinator controllable through said handle to internally marinate said meat with assistance from the vibrational or other work forces introduced by said tenderizer.

2. The meat preparation device of claim 1 wherein said vibrational or other work forces introduced by said tenderizer are provided by a motorized vibrator.

3. The meat preparation device of claim 1 wherein said vibrational or other work forces introduced by said tenderizer are provided by the natural motion and action of said tenderizer due to manual operation thereof by a user.

4. The meat preparation device of claim 1 wherein said handle comprises a marinator activation switch.

5. The meat preparation device of claim 1 wherein said handle comprises a vibration indicator light and a marination indicator light.

6. The meat preparation device of claim 1 wherein said meat tenderizer comprises a plurality of meat tenderizing blades.

7. The meat preparation device of claim 1 wherein said marinator comprises a marination reservoir.

8. The meat preparation device of claim 1 wherein said marinator comprises at least one marinating injection needle.

9. The meat preparation device of claim 1 wherein said marinator comprises a marination flow path for transporting a marinade from a marination reservoir into and through at least one injection needle.

10. A method for tenderizing meat, comprising:
selecting a hand-operable meat tenderizer, comprising:
a handle;
a meat tenderizer controllable through said handle to tenderize a cut of meat while introducing vibrational or other work forces therein; and
a marinator controllable through said handle to internally marinate said meat with assistance from the vibrational or other work forces introduced by said tenderizer;
grasping said handle; and
tenderizing said meat with said tenderizer while marinating said meat with said marinator.

11. The method of claim 10 wherein said vibrational or other work forces introduced by said tenderizer are provided by a motorized vibrator.

12. The method of claim 10 wherein said vibrational or other work forces introduced by said tenderizer are provided by the natural motion and action of said tenderizer due to manual operation thereof by a user.

13. The method of claim 10 wherein said handle comprises a marinator activation switch and said method comprises activating said switch during use of said tenderizer.

14. The method of claim 10 wherein said handle comprises a vibration indicator light and a marination indicator light.

15. The method of claim 10 wherein said meat tenderizer comprises a plurality of meat tenderizing blades.

16. The method of claim 1 wherein said marinator comprises a marination reservoir.

17. The method of claim 1 wherein said marinator comprises at least one marinating injection needle.

18. The method of claim 1 wherein said marinator comprises a marination flow path for transporting a marinade from a marination reservoir into and through at least one injection needle.

19. A hand operable meat tenderizer and marinator, comprising:
a handle;
a plurality of meat tenderizing blades;
a marination reservoir;
at least one marinating injection needle; and
a flow path for transporting a marinade from said reservoir into and through said at least one injection needle.

20. The hand operable meat tenderizer and marinator of claim 19 further including a motorized vibration inducing device effective to vibrate said meat tenderizing blades.
